(19) United States
(12) Patent Application Publication
(10) Pub. No.: US 2013/0211883 A1
(43) Pub. Date: Aug. 15, 2013

(54) METHODS AND APPARATUS FOR EVALUATING MEMBERS OF A PROFESSIONAL COMMUNITY

(71) Applicants: Ryan Edwin Vesely, Menlo Park, CA (US); Babak Yazdani, Potomac, MD (US); Bernard P. Willis, San Francisco, CA (US)

(72) Inventors: Ryan Edwin Vesely, Menlo Park, CA (US); Babak Yazdani, Potomac, MD (US); Bernard P. Willis, San Francisco, CA (US)

(73) Assignee: Saba Software, Inc., Redwood Shores, CA (US)

(21) Appl. No.: 13/371,451

(22) Filed: Feb. 12, 2012

(51) Int. Cl. G06Q 10/06

(52) U.S. Cl. 705/7.39

(57) ABSTRACT

Techniques for evaluating a person who is a member of a professional community involve collecting quantitative information regarding the person's participation in at least one social network. The quantitative information may be incorporated in computing a score indicating the person's value to the professional community.

### BACKGROUND

Corporations, companies or other entities (hereafter referred to as “employers”) who hire significant numbers of employees typically require a system of some sort to manage those employees. Often this service is performed by a Human Resources (HR) department of the employer entity, which is charged with ensuring that the employer is sufficiently staffed to efficiently conduct its business on a day-to-day basis. This may involve hiring employees, establishing and disbursing appropriate compensation and benefits, conducting performance reviews, monitoring employee absences and withdrawals, and terminating employees as necessary. Typically these HR tasks are performed by a staff of personnel (themselves employees) who bring their human experience and training to bear on monitoring employees and taking necessary actions to ensure that the employer is efficiently and consistently staffed. As used herein, the term “employee” refers to a person working for an employer entity, and the set of services the person is expected to provide to the entity as part of the person's employment is referred to as the person's “job.”

Conducting performance reviews is an important function of the typical HR department of an employer entity. A conventional performance review is typically an annual process in which individual employees are evaluated as to how well they have performed their jobs over the past year. Each employee's managers and/or supervisors (both referred to herein as “managers”) typically provide narrative reviews of the employee's job performance over the past year, noting significant accomplishments and/or failures, and providing suggestions for ways to improve performance. Often, managers are asked to subjectively rate employees, e.g., on a scale from one to five, on characteristics such as “responsiveness” and “accountability,” bearing on the employees' ability to effectively and efficiently perform their jobs. Employees are also often asked to complete self-evaluations as part of the performance review process, subjectively rating their own job performance, and/or providing narrative reflections on their progress over the past year and/or on their plans for the upcoming year. These manager performance reviews and/or employee self-evaluations then typically become part of the employee's personnel file, and are used for reference in setting compensation levels, hiring for promotions, justifying terminations, etc.

### SUMMARY

One type of embodiment is directed to a method for evaluating a person who is a member of a professional community, the method comprising collecting, using at least one processor, quantitative information regarding the person's participation in at least one social network; and incorporating the quantitative information in computing a score indicating the person's value to the professional community.

Another type of embodiment is directed to apparatus comprising at least one processor and at least one computer-readable medium storing processor-executable instructions that, when executed by the at least one processor, perform a method for evaluating a person who is a member of a professional community, the method comprising collecting quantitative information regarding the person's participation in at least one social network, and incorporating the quantitative information in computing a score indicating the person's value to the professional community.

Another type of embodiment is directed to at least one computer-readable storage medium encoded with computer-executable instructions that, when executed, perform a method for evaluating a person who is a member of a professional community, the method comprising collecting quantitative information regarding the person's participation in at least one social network, and incorporating the quantitative information in computing a score indicating the person's value to the professional community.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram illustrating an exemplary operating environment for a system in accordance with some embodiments of the present invention;

FIG. 2 is a flowchart illustrating an exemplary method for evaluating a member of a professional community, in accordance with some embodiments of the present invention;

FIG. 3 is a flowchart illustrating an exemplary method for computing an evaluation score in accordance with some embodiments of the present invention; and

FIG. 4 is a block diagram illustrating an exemplary computer system on which aspects of the present invention may be implemented.

### DETAILED DESCRIPTION

The inventors have appreciated that traditional methods of evaluating employees through formal performance reviews have become increasingly inadequate in a competitive economy. As employers compete for market share and reputation, there is continually increasing demand for ways to effectively identify and develop human resources that can be harnessed to add value to a community. Particularly valuable to employers are people with the potential to be leaders, who can influence other members of the community and bring about positive change. The inventors have recognized that traditional methods of evaluation are inadequate to identify and encourage these “movers and shakers” who have the potential for greatest positive impact on the community, particularly if these people are not already in positions of leadership. For instance, a traditional performance review that only evaluates how well a person is performing the specific tasks required by the person's current job may not be effective in identifying and cultivating leadership potential in a person whose current job does not involve the performance of leadership-oriented tasks. The inventors have recognized that a person's capacity to impact a community may be better assessed by expanding the scope of evaluation to consider informal aspects such as interaction with and learning from other members of the community in social contexts. As used herein, the term “social” is not restricted to contexts unrelated to work, but is used to refer to communication between and among people, whether or not related to the performance of those people's jobs. The inventors have recognized that a novel holistic approach to evaluating members of a community, one that accounts for informal interaction in addition to formal job requirements, may be more effective in measuring a person's influence on the community, and in recognizing hidden talent in aspects outside of a person's current job description.

The inventors have also appreciated that the subjectivity and relative infrequency of traditional performance review methods fosters inaccuracies, even with respect to formal aspects of a person's job being evaluated. When asked to subjectively rate an employee's job performance on a scale from one to five, a manager may have difficulty assigning a number that accurately reflects the employee's actual performance and that rates the employee fairly and consistently with respect to other employees. Different managers may map the numeric scale differently to the continuum of actual observances, and much of an employee's work may not be observed by a manager and may thus go unnoticed in the performance review process. In addition, reliance on a human manager's or employee's memory in recounting what was accomplished over the period in review invariably leaves out details that are not recalled at the time the review is completed, especially under the traditional practice of conducting performance reviews only once per year. Furthermore, managers and employees alike often give short shrift to the performance review process, because it is time consuming and an annoying distraction from other work that needs to be completed as part of the managers' and employees' jobs. All of these factors, as well as others, can give rise to traditional performance reviews that carry little informational value. The inventors have thus recognized that significant improvement may be gained through use of an automated and continuous process to record and credit the actual work that an employee performs throughout the year, making the evaluation process more objective, less time consuming for the personnel involved, and less reliant on human memory over relatively long timespans.

The inventors have further appreciated that a key inadequacy of the traditional performance review process results from its reflective, after-the-fact nature. The very concept of an annual “review” is to look backward and comment upon the previous year, by which time it may be too late to correct unproductive behavior or to implement more valuable practices. Although traditional performance reviews often involve suggestions for future improvement, the fact that the next performance review is a whole year away in the future may cause an employee to disregard the suggestions made this year, or to implement some suggestions for a little while but forget about them well before the next review. The inventors have appreciated that employees often regard the traditional performance review simply as punishment for the shortcomings of the previous year, without much useful benefit for improving the next year. The inventors have recognized, however, that employers and employees alike may find greater benefit in a more continuous system of evaluation that is transparent to the employee. By being given access to a dynamically updating evaluation score throughout the year, an employee may be empowered to make constructive changes and to learn how to increase his/her evaluation score in advance of a more formal review process. The resulting encouragement of employee self-improvement may aid the employer in more effectively retaining and developing talent in its human resources, benefitting and adding value to the community as a whole.

In addition, the inventors have recognized that a real-time and transparent evaluation system accessible at the employee's convenience throughout the year may provide personal benefit to the employee through feedback on development choices. An employee may be aided in identifying and implementing strategic actions that will improve his/her evaluation score, based on feedback provided by an automated and dynamically updating evaluation system. The inventors have appreciated that in a competitive economy, individuals have a need to identify as many ways as possible to make themselves marketable and increase their attractiveness to employers and others in the community. When an employee's job description involves skills and/or accomplishments that are equally attainable by many others at the same level, more is needed to differentiate oneself from the crowd to attract attention and promotion. The inventors have recognized that this may be achieved through an evaluation system that is multifaceted, taking into account considerations other than a person's formal job requirements, such as informal interactions, and through providing feedback to the employee regarding how individual facets contribute to the overall evaluation.

A further shortcoming of the traditional performance review process that the inventors have appreciated is the lack of consistency between reviews of different employees. When reviews are based on individual human memory and perception, it may be impossible to ensure that different people are truly evaluated on the same scale. The inventors have recognized that the effectiveness of an evaluation system may be enhanced by utilizing consistent, objective and quantitative measurements, and by weighting inputs consistently across those being evaluated. The inventors have further recognized that evaluation scores with commonality of measurement, when normalized with respect to the community of which the person being evaluated is a member, may provide the member with an understandable and useful benchmark of his or her value in relation to other members of the community. Such a benchmark may be helpful in aiding an individual to recognize when improvement is needed, in monitoring when improvement is successful, and in psychologically motivating the individual to maintain an evaluation that compares favorably with other members of the community. Furthermore, the inventors have recognized that such an evaluation system may be integrated within a social network to surface the evaluation process in a way that is competitive and fun, and that engages individuals to improve their value to a community.

The inventors have also appreciated that conventional performance review processes have been limited to evaluating employees of a particular employer or set of employers. The inventors have recognized that it may be useful to allow for people to be evaluated based upon their membership in and/or contributions to a less restricted professional community, which may also include people who are not employees but nevertheless have professional relationships with a set of one or more employers that are of interest in evaluating their impact on the professional community. Such people may include, for instance, an employer entity's customers, business partners, board of directors, and/or people with any other suitable professional relationship(s) of interest.

Accordingly, some embodiments described herein relate to techniques for evaluating members of a professional community, in ways that may address one or more of the above-discussed shortcomings of traditional evaluation methods, and/or that may provide one or more of the foregoing benefits. However, aspects of the invention are not limited to any of these benefits, and it should be appreciated that some embodiments may not provide any of the above-discussed benefits and/or may not address any of the above-discussed deficiencies that the inventors have recognized in conventional techniques.

As used herein, a “professional community” refers to a set of people whose membership is defined and/or restricted based at least in part on the people's professional relationships with a set of one or more employers. For example, a professional community may include employees of an employer or group of employers, or a subset of employees of an employer or group of employers. In other examples, a professional community may not be limited solely to employees. For instance, a professional community could be formed to include one or more employers' employees or a subset of those employees, plus one or more non-employees having particular professional relationships with the one or more employers. For example, a professional community could be formed to include employees, customers, business partners, and/or the board of directors of an employer. It should be appreciated that this is merely an example, and that professional communities as referred to herein are not limited to any particular set of categories of people, but may include any suitable people having any suitable form of professional relationship with one or more employers. In some embodiments, a professional community may be defined by and/or coextensive with a set of people having access to an online network with limited membership, where the online network is provided by, maintained by, sponsored by and/or otherwise associated with a set of one or more employer entities. However, other embodiments may not require any particular relationship between a professional community and any particular online network, as aspects of the invention are not limited in this respect.

In some embodiments, individual members of a professional community may be evaluated to determine their value to the professional community. In some embodiments, the evaluation may be conducted in a way that considers aspects of the members' participation in one or more social networks. For instance, in some embodiments, a social network may be maintained whose membership is coextensive with the membership of the professional community, or whose membership includes a subset of the members of the professional community. Such a social network, all of whose members are members of the professional community, is referred to herein as being internal to the community. By contrast, a social network whose membership is not restricted to members of the professional community, including a social network whose membership is open to the general public, is referred to herein as being external to the community. As used herein, a “social network” refers to a computerized platform allowing a plurality of online users to communicate and to post personal information in an online “profile.”

In some embodiments, a person's level of participation in a social network may be measured in a quantitative way. Examples include measuring the number of other people to which the person is linked within the social network; the number, frequency and/or type of interactions the person has with other people on the social network; and the number, frequency and/or type of object-related interactions the person has on the social network. These and other examples are discussed below. In some embodiments, such quantitative information may be considered as measurements of the person's influence on others within the social network, and/or of others' influence on the person within the social network.

In some embodiments, the quantitative information regarding the person's participation in the one or more social networks may be combined with one or more other inputs to compute a score indicating the person's value to the professional community. Examples of suitable other inputs include measures of the person's compliance with learning requirements, the person's performance of job requirements, the person's skill set, and other inputs as described below. In some embodiments, a set of weights may be configured to be applied to these multiple input categories (hereafter referred to as “facets”) in computing the person's combined evaluation score, such that some facets may be weighted more heavily than others in the overall score. In some embodiments, the same set of weights for the same set of facets may be applied in evaluating different members of the professional community, to promote consistency and the ability to benchmark with relation to other members of the professional community.

In some embodiments, a member's evaluation score, and/or the facets and/or individual input measurements used in computing the score, may be displayed or otherwise indicated to the member to allow him/her to understand his/her current valuation within the professional community. In some embodiments, access to this information may be provided at the member's convenience throughout the year; however, aspects of the invention are not limited to any particular timing or frequency of access to a member's evaluation score. In some embodiments, a member may be provided access to his/her evaluation score outside of the context of a formal performance review, such that he/she has a chance to work on improving the score before the formal review process actually occurs. In some embodiments, an interface may be provided that allows the user to input hypothetical changes to the individual measurements and/or facets contributing to his/her evaluation score, and an indication may be provided of how the computed score would change if the hypothetical input changes were to be actually implemented through the user's actions in life.

It should be appreciated that the foregoing description is by way of example only, and aspects of the invention are not limited to providing any or all of the above-described functionality, although some embodiments may provide some or all of the functionality described herein.

The aspects of the present invention described herein can be implemented in any of numerous ways, and are not limited to any particular implementation techniques. Thus, while examples of specific implementation techniques are described below, it should be appreciate that the examples are provided merely for purposes of illustration, and that other implementations are possible.

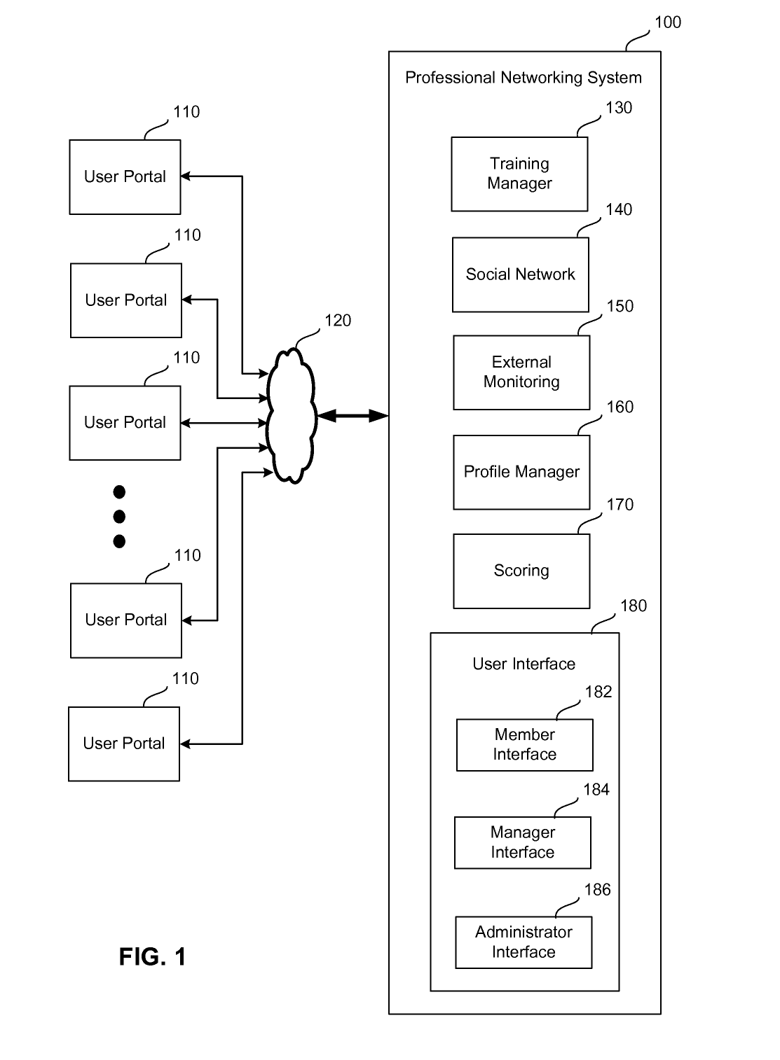

One illustrative application for the techniques described herein is for use in a system for evaluating members of a professional community. An exemplary operating environment for such a system is illustrated in FIG. 1. The exemplary operating environment includes a professional networking system 100, which may be implemented in any suitable form, as aspects of the present invention are not limited in this respect. For example, system 100 may be implemented as a single stand-alone machine, or may be implemented by multiple distributed machines that share processing tasks in any suitable manner. System 100 may be implemented as one or more computers; an example of a suitable computer is described below. In some embodiments, system 100 may include one or more tangible, non-transitory computer-readable storage devices storing processor-executable instructions, and one or more processors that execute the processor-executable instructions to perform the functions described herein. The storage devices may be implemented as computer-readable storage media (i.e., tangible, non-transitory computer-readable media) encoded with the processor-executable instructions; examples of suitable computer-readable storage media are discussed below.

As depicted, system 100 includes training manager 130, social network component 140, external monitoring component 150, profile manager 160, scoring component 170 and user interface 180. Each of these processing components of system 100 may be implemented in software, hardware, or a combination of software and hardware. Components implemented in software may comprise sets of processor-executable instructions that may be executed by the one or more processors of system 100 to perform the functionality described herein. Each of training manager 130, social network component 140, external monitoring component 150, profile manager 160, scoring component 170 and user interface 180 may be implemented as a separate component of system 100 (e.g., implemented by hardware and/or software code that is independent and performs dedicated functions of the component), or any combination of these components may be integrated into a single component or a set of distributed components (e.g., hardware and/or software code that performs two or more of the functions described herein may be integrated, the performance of shared code may be distributed among two or more hardware modules, etc.). In addition, any one of training manager 130, social network component 140, external monitoring component 150, profile manager 160, scoring component 170 and user interface 180 may be implemented as a set of multiple software and/or hardware components. Although the example operating environment of FIG. 1 depicts training manager 130, social network component 140, external monitoring component 150, profile manager 160, scoring component 170 and user interface 180 implemented together on system 100, this is only an example; in other examples, any or all of the components may be implemented on one or more separate machines, or parts of any or all of the components may be implemented across multiple machines in a distributed fashion and/or in various combinations. It should be understood that any such component depicted in FIG. 1 is not limited to any particular software and/or hardware implementation and/or configuration.

In some embodiments, professional networking system 100 may be accessible by one or more users via one or more user portals 110. User portals 110 may be implemented in any suitable manner, including as one or more computers and/or terminals, which may be local to and/or remote from professional networking system 100, as aspects of the present invention are not limited in this respect. User portals 110 may be connected to and/or may communicate with professional networking system 100 via any suitable connection(s), including wired and/or wireless connections. In the example depicted in FIG. 1, user portals 110 transmit data to and receive data from professional networking system 100 through network 120. Network 120 may be any suitable network or combination of networks, including local and/or wide area networks, and may make use of any suitable wired and/or wireless connections. For example, network 120 may be a private network, such as a professional network accessible to members (e.g., employees, customers, partners, etc.) of a professional community having professional relationships with one or more employers, or a public network such as the Internet, or a combination of both types of networks.

In some embodiments, users within the professional community may use user portals 110 to access professional networking system 100 via user interface 180, and professional networking system 100 may in turn collect data regarding the users' use of the tools provided by professional networking system 100. Users accessing user portals 110 may include any members of the professional community, and optionally any other people for whom access to professional networking system 100 is considered appropriate. When a user accesses professional networking system 100 to perform actions that will be considered as part of the user's own evaluation, or when the user accesses professional networking system 100 to view and/or otherwise interact with the user's own evaluation, the system may treat that user as a generic member of the professional community. When a user responsible for the professional development of other members accesses professional networking system 100 to view and/or otherwise interact with evaluations of those other members, and/or to set criteria for evaluation of those members, the system may treat that user as a manager, provided the user has the required access authorization for that category of user. When a user accesses professional networking system 100 to set criteria for the evaluation of members across the professional community as a whole, and/or to otherwise configure the standard processing performed by scoring component 170 and/or by other components of professional networking system 100, the system may treat that user as an administrator, provided the user has the required access authorization for that category of user. It should be appreciated, however, that user categories such as “administrator,” “manager” and generic “member” are merely examples, and other designations are possible. In some alternative embodiments, users may not be designated with predefined categories, but may instead have collections of any of various available access rights that determine what aspects of professional networking system 100 they are authorized to use and/or configure.

In some embodiments, user interface 180 may be configured, e.g., through appropriate programming of one or more processors of professional networking system 100, to provide data to and receive data from a user portal 110 in accordance with the access rights of the current user engaging that portal. For example, in some embodiments, user interface 180 may have different subcomponents for presenting member interface 182, manager interface 184 and administrator interface 186.

In some embodiments, functions enabled by member interface 182 may be accessible to all people who are members of the professional community, including administrators, managers and generic members. Member interface 182 may provide access, for example, to functions of professional networking system that evaluate a member and/or that allow the member to view and/or otherwise interact with the member's evaluation score, as described below.

In some embodiments, functions enabled by manager interface 184 may be accessible only to users who manage other members and have access rights corresponding to the manager designation. Such functions may include, for example, the ability for the user to view the evaluation scores of other members, and/or to set goals, learning and/or skill requirements and/or other criteria to be used in evaluating the members managed by the user, as described below. A set of people including a manager and the members managed by that manager is referred to herein as a “manager group.” In some embodiments, managers may access functions enabled by manager interface 184 by logging in with credentials, such as user identifiers and/or passwords, that establish their access rights as managers.

In some embodiments, functions enabled by administrator interface 186 may be accessible only to users responsible for configuring various aspects of professional networking system 100, and/or for establishing criteria by which members are evaluated across the professional community or across sub-communities within the professional community that include multiple manager groups. For example, in some embodiments administrator interface 186 may allow an administrator to specify a set of input categories (“facets”) upon which members of the community are to be evaluated, and/or may allow an administrator to configure a set of weights to be applied to the input facets in computing a member's evaluation score, as described below. In some embodiments, administrators may access functions enabled by administrator interface 186 by logging in with credentials, such as user identifiers and/or passwords, that establish their access rights as administrators.

As discussed above, any member of a professional community, including a manager or an administrator, can be considered a generic member, and his/her value to the professional community can be scored using techniques described herein. In some embodiments, a person may belong to a professional community as a generic member, a manager and an administrator, or any other combination thereof, simultaneously. Such a user may, for example, perform administrator functions by accessing administrator interface 186 (with the appropriate credentials), perform manager functions by accessing manager interface 184 (with the appropriate credentials), and access the user's own member evaluation functions via member interface 182. This is only an example, however, as aspects of the invention are not limited to any particular configuration for user interface 180. In some alternate embodiments, user interface 180 may not have separate components for member, manager and administrator interfaces, but may instead present a common interface with certain functions being disabled for users having inadequate access rights, or being visible only to users with appropriate access rights. Commonly, a professional community may need only a few administrators to configure and/or maintain professional networking system 100, and may have significantly larger numbers of managers and even larger numbers of generic members. However, this is only an example, as aspects of the invention are not limited to any particular hierarchical structure for a professional community. In some embodiments, professional networking system 100 may not treat users as generic members, managers and administrators, but may regulate access rights in any suitable way, such as on an individual basis. Also, in some embodiments, certain roles, such as some administrator roles, may be performed by people who are not official members of the professional community, such as by human resources and/or computer programming specialists specifically engaged to perform administrative functions with respect to professional networking system 100.

In some embodiments, members may access professional networking system 100, e.g., via network 120 and user interface 180, and may interact with components of professional networking system 100 as part of their regular professional participation in the professional community. In some embodiments, these interactions may be monitored or otherwise aggregated and/or analyzed as part of computing evaluation scores for individual members. Any suitable interactions with and/or actions performed via any suitable component(s) of professional networking system 100 may be monitored and/or otherwise utilized in evaluating a member of the professional community, as aspects of the invention are not limited in this respect. However, some embodiments may provide for evaluation with reference to a member's use of particular components such as training manager 130, social network component 140, external monitoring component 150 and/or profile manager 160, as described further below.

In some embodiments, training manager 130 may provide, e.g., through appropriate processing performed by one or more processors of professional networking system 100, training and/or certification tools usable by members of the professional community. These may include, for example, online and/or paper-based training courses, seminars and/or webinars, tests and examinations, reference materials, and/or any other suitable training and/or certification tools. In some embodiments, use of some or all of these training tools may be required for some or all of the members of the professional community, e.g., as part of the members' formal job requirements. For example, a member whose job requires use of a particular software application may be required to complete a training course in the use of that software application, and a member whose job requires compliance with a particular safety protocol may be required to complete an examination to gain formal certification in the knowledge of that safety protocol.

In some embodiments, training and/or certification requirements (hereafter referred to as “learning requirements”) may be assigned to an individual member of the professional community automatically based on his/her job title, job description, manager group affiliation, and/or any other suitable criteria. Such automatic assignment may be performed in any suitable way. For example, training manager 130 may be programmed to assign appropriate learning requirements to one or more members of the professional community based on current job information stored, e.g., in the members' personal profiles by profile manager 160. In some embodiments, one or more administrators may specify which learning requirements apply to which job categories, and training manager 130 may then automatically apply the requirements as specified to members across the professional community. Alternatively or additionally, managers may assign particular learning requirements to their manager groups, or to individual members of their manager groups. For example, if an individual member has been involved in a negative safety incident, the member's manager may decide to assign a safety training and/or re-certification requirement to that member. In some embodiments, training manager 130 may be programmed to automatically assign individual learning requirements based on such triggering events and/or any other suitable criteria. Individual members of the professional community may be notified of their assigned learning requirements in any suitable way; for example, by notifications appearing on their personal profiles corresponding to data stored and/or maintained by profile manager 160.

In some embodiments, social network component 140 may provide, e.g., through appropriate processing performed by one or more processors of professional networking system 100, infrastructure for running and/or maintaining a social network usable by members of the professional community. As discussed above, the social network may provide an online space for each member to build a unique profile containing personal information. The social network may also provide the capability for members to link their profiles with the profiles of other members with whom they are acquainted, with whom they share a manager group and/or job title, and/or with whom they have any other suitable association. Such links may be represented, for example, by listing on a member's profile the names and/or other information of the other members to whom the member is linked, or in any other suitable way. Alternatively or additionally, the social network may provide the capability for a member to “follow” one or more other members, by receiving suitable notifications when the other members being followed post information to their profiles or to other spaces within the social network.

Items of information posted to a social network are referred to herein as “objects,” and may include free text, posts to blogs, discussion topics, links to electronic files, links to webpages, event postings, and/or any other item of information suitable for posting to a social network. In some embodiments, once an object has been contributed to a social network by being initially posted by a member, it may be shared with other targeted members within the social network. For instance, once a first member has contributed an object by posting it to the first member's profile, to a discussion board or to any other suitable space on the social network, a second member who notices the posted object may direct a third member to view the object (i.e., the second member may share the object with the third member). Such sharing may be accomplished in any suitable way—for instance, by allowing the second member, upon viewing the object, to send a message to the third member within the social network, containing a link to the object. In some embodiments, the social network may allow members to perform any of various actions on objects contributed to the social network, which may include viewing the object, sharing the object, rating the object, ranking the object, bookmarking the object, commenting on the object, and/or any other suitable action.

Alternatively or additionally, in some embodiments the social network may allow members to perform any of various actions on other members on the social network, which may include viewing a member's profile, sharing a member's profile, rating a member, ranking a member, bookmarking a member's profile, posting a comment or other object on another member's profile, providing an impression on a member, and/or any other suitable action. Providing an impression on another member may include posting to the social network a comment about a quality of the other member and/or about something the other member did, such as, “This person impressed me because she gave a great lecture yesterday,” or “This person is a great mentor.” It should be appreciated, however, that the foregoing are only examples, and any suitable social networking functions may be provided by one or more components of professional networking system 100, such as social network component 140, as aspects of the invention are not limited in this respect.

In some embodiments, external monitoring component 150 may be programmed to monitor, e.g., through appropriate processing performed by one or more processors of professional networking system 100, members' actions performed outside the professional community. Any suitable external actions may be monitored, as aspects of the invention are not limited in this respect. In some embodiments, a set of external actions to be monitored may be specified by one or more administrators, managers and/or other suitable personnel, and may be the same for all members of the professional community or may differ between members of the community. In some embodiments, external monitoring component 150 may collect information regarding a member's participation in one or more social networks external to the professional community. Examples of suitable external social networks include, but are not limited to, Twitter™, Facebook™ and Linkedin™. Information regarding a person's participation in an external social network may be collected in any suitable way, as aspects of the invention are not limited in this respect. For example, in some embodiments, external monitoring component 150 may poll, e.g., via the Internet and/or any other suitable network connection(s), one or more servers corresponding to an external social network to retrieve data regarding information the person has posted to the external social network, information that has been associated with the person on the external social network, actions the person has taken within the external social network, and/or any other related information. Alternatively or additionally, in some embodiments external monitoring component 150 may passively receive data regarding the person's participation in an external social network from the external social network's one or more servers, and/or from one or more third-party monitoring services. Such a third-party monitoring service may collect data from one or more external social networks and forward the data to external monitoring component 150, and/or may aggregate the collected data into one or more consolidated measures and provide those measures to external monitoring component 150. One example of a suitable third-party aggregated measure is the Klout™ score, which may be used by professional networking system 100 as a measure of a member's influence within one or more communities external to the professional community. Many other examples are possible, and aspects of the invention are not limited to any particular method of third-party monitoring, or in general to any particular method of monitoring external information.

In some embodiments, profile manager 160 may be configured to store and/or maintain, e.g., through appropriate processing performed by one or more processors of professional networking system 100, unique profile information for individual members of the professional community. Such profile information may include, for example, basic biographical information about the member and/or information about the member's current and/or previous jobs, which may be entered by the member, manager(s) and/or administrator(s) upon hiring the member, upon engaging the member for a particular job, and/or at any other suitable time. In some embodiments, a member may access profile manager 160, e.g., via user portal 110 and member interface 182, to view and/or update information in his/her profile. In some embodiments, the member's profile information may also be accessible to one or more managers and/or administrators, e.g., via user portal 110 and manager interface 184 and/or administrator interface 186, respectively. In some embodiments, managers and/or administrators may have unlimited view and/or update access to member profiles, while in other embodiments, managers and/or administrators may have any of various suitable combinations of predetermined and/or configurable access rights to profiles of other members. In some embodiments, administrators may have view and/or update access to more member profiles than managers; for example, in some embodiments, manager access rights may be limited to the profiles of members within their own manager groups. Any suitable manager and/or administrator access rights to member profiles may be implemented, as aspects of the invention are not limited in this respect.

In some embodiments, certain members, managers and/or administrators may have access to view profile information of other members, but not to update or otherwise change the information. In some embodiments, a member's profile may be viewable by all members of the professional community, while in other embodiments, view access to a member's profile may be limited in any suitable way, such as by job category, by manager group affiliation, and/or any other suitable criteria. In some embodiments, view and/or update access to a member's profile may be configurable by the member, manager(s) and/or administrator(s), such that certain other members can be designated for view and/or update access to the member's profile while others are not. In some embodiments, certain information within a member's profile may be viewable and/or updatable by others while other information is not, and certain information may be viewable and/or updatable only by certain other members. Such division of access rights to different information within a member's profile may be set by default, configurable by the member, manager(s) and/or administrator(s), and/or determined in any other suitable way. In some embodiments, a member may have “public” profile information viewable by other members of the professional community, and different “private” profile information (which may overlap with the public information) viewable only to the member, or only to the member and limited other members, such as managers and/or administrators. Alternatively or additionally, a member's profile may have different (possibly overlapping) sets of non-public information viewable by different levels of managers and/or administrators. In some embodiments, a member's profile may even contain information that is not accessible to the member him/herself, but is only accessible to one or more managers and/or administrators. The foregoing are merely examples, however, as aspects of the invention are not limited to any particular implementation of access to profile information. Access rights may be configurable in any suitable way, such as by default programming and/or via case-by-case specification of access rights, e.g., by an administrator or other suitable personnel.

In some embodiments, a member's profile information as stored and/or maintained by profile manager 160 may include information in the member's online profile stored and/or maintained by social network component 140, and/or profile manager 160 may have access to online profile information managed by social network component 140. In some embodiments, profile information managed by profile manager 160 may be coextensive with online profile information available to the social network; while in other embodiments, some information may be managed by profile manager 160 that is not available to the social network, and/or some information may be managed by social network component 140 that is not managed by profile manager 160. In some embodiments, profile manager 160 may function to manage all of a member's profile information, and may make some or all of that information available to the social network. These and any other suitable implementations of profile management are possible, as aspects of the invention are not limited in this respect.

In some embodiments, profile manager 160 may store and/or maintain, in a member's profile, information that may be used to determine one or more measures of the member's value to the professional community. Any suitable information may be used in this determination, as aspects of the invention are not limited in this respect, although some embodiments provide for the consideration of particular categories (facets) of information. Examples of suitable facets (i.e., categories of inputs), as described further below, include, but are not limited to, learning information, effectiveness information, informal engagement information, information regarding profile completion, information regarding skills, and external sources of information. It should be appreciated, however, that these are merely examples, and aspects of the invention are not limited to the inclusion of any of the foregoing facets in evaluating a member of a professional community.

In some embodiments, scoring component 170 may be programmed to compute, e.g., through processing performed by one or more processors of professional networking system 100, one or more evaluation scores indicating a member's value to the professional community. In some embodiments, this process may include collecting input information corresponding to a number of specified facets to be used in the computation. In some embodiments, some or all of the input information may be stored and/or maintained by profile manager 160, and scoring component 170 may collect the input information via communication with profile manager 160. Profile manager 160 may in turn receive appropriate inputs from other components of professional networking system 100. Alternatively or additionally, in some embodiments some or all of the input information may be stored and/or managed separately by various components of professional networking system 100, such as training manager 130, social network component 140, external monitoring component 150 and/or profile manager 160, and scoring component 170 may collect the input information via communicating accordingly with these various components.

In some exemplary embodiments, as discussed above, input information collected by scoring component 170 may correspond to facets including learning, effectiveness, informal engagement, profile completion, skills, and external sources. To provide a detailed example of the techniques disclosed herein, these exemplary facets are described further below. However, it should be appreciated that the following discussion is by way of example only, and that aspects of the invention are not limited to any particular number or type of input facets. Some embodiments may not utilize multiple input facets, and some embodiments may utilize different facets than those described below.

In some embodiments, a learning facet may represent a measure of how compliant a member is with the formal learning requirements for his/her job, and/or how much initiative the member has taken to formally learn things outside of his/her job requirements. In some embodiments, input information corresponding to the learning facet may be collected by scoring component 170 from training manager 130, e.g., directly or via profile manager 160. Relevant input information may include what training and/or certification courses, examinations and/or other offerings have been successfully completed by the member (e.g., as recorded by training manager 130), and/or what relationship various available learning offerings have to the member's current job and/or to other jobs.

In some exemplary embodiments, an aggregate value may be computed for an input facet by assigning quantitative values (such as numbers of points) to specified items of input information, and then combining the resulting quantitative values (such as by summing them) into an aggregate value. In some embodiments, the items of input information specified for consideration and the quantitative values assigned to them may be made constant across the professional community, or across appropriate subsets of the professional community, such that members are evaluated in a consistent fashion. For example, one or more administrators or other suitable personnel may in some embodiments specify the input items to be considered and the quantitative values to be assigned for them for the professional community as a whole, for members of particular job categories, for members of particular manager groups, and/or for any other suitable division of members based on shared characteristics and/or affiliations.

For example, for the learning facet, some possible implementations may add specified numbers of points to an aggregate value for the following items of input information:
Successful completion(s) of training offering(s), certification requirement(s) and/or other learning offering(s) required for the member's current job.
Successful completion(s) of training offering(s), certification requirement(s) and/or other learning offering(s) assigned to the member by a manager or administrator, and/or assigned automatically based on a triggering event.
Successful completion(s) of training offering(s), certification requirement(s) and/or other learning offering(s) in which the member enrolled and which are aligned to recognized job(s) and/or skill(s), although not required for the member's current job and not assigned to the member.
Social networking actions performed on completed learning offering(s), such as posting information about them to the social network, and/or recommending them to other members of the social network.

In some embodiments, administrator(s) or other suitable personnel may specify the number of points to be assigned to different items of input information to reflect the different levels of importance that different items may have to the particular professional community, to a particular job category, to a particular manager group, and/or based on any other suitable criteria. For example, a professional community in an industry with strict certification requirements may value compliance with certification requirements more heavily than other input items. In another example, a group within a professional community may want to increase collaboration or mentorship within its members, and therefore may assign a higher value to social networking actions than to other input items. In some embodiments, negative points may also be assigned to input items that decrease a member's value to the professional community, such as certifications that become expired or revoked, or required learning offerings that are overdue for completion. In some embodiments, input items and/or assigned points may reflect a proportion of learning requirements completed, rather than or in addition to absolute numbers. Thus, for example, a member who has completed a large proportion of a large number of required learning offerings could receive a higher number of points than a member who has completed all learning requirements but whose job had fewer learning requirements to begin with.

In some embodiments, an effectiveness facet may represent a measure of how well a member performs the formal work involved in his/her job. Any suitable input information may be specified, e.g., by an administrator, for collection to determine this measure. In one example, a member's manager may set goals that the member is expected to achieve, and may input these goals to the member's profile information as managed by profile manager 160. Goals may be of any suitable type and/or form. One example of a suitable goal could be, “Construct 15 widgets within the next month.” The member may then report back when the goal is completed, e.g., by updating information managed by profile manager 160. Alternatively or additionally, the member may provide incremental progress reports, such as updating the profile information when a certain percentage of the goal has been completed or a certain number of the total widgets have been constructed. In some embodiments, progress reports and/or completion updates may be collected automatically if appropriate data is available to professional networking system 100, e.g., about an automatically ascertainable metric such as a member's progress toward a sales quota. In some embodiments, managers and/or other personnel (possibly including other generic members) may provide subjective commentary and/or suggestions for improvement on the member's effectiveness at his/her job. Such commentary and/or suggestions may be input, for example, to profile manager 160, and/or may be posted to the member's online profile as managed by social network component 140. Other inputs may include formal performance review ratings, as well as trends comparing previous years' performance reviews with the most recent performance review. Thus, in some exemplary possible implementations, an aggregate value may be computed for the effectiveness facet through assigning points to the following items of input information:
Goals assigned to the member.
Goals that the member assigns to him/herself, especially if the member indicates that the self-assigned goals are aligned with other goals assigned to the member.
Progress updates on goals.
Completion of goals.
Commentary and/or suggestions given to the member on the social network.
Overdue goals not completed (e.g., negative points).
Performance review trend (e.g., positive or negative).

In some embodiments, an informal engagement facet may represent a measure of a member's influence on other members within the professional community, e.g., through social networking, which may in turn be relevant to assessing the member's impact on the community as a whole. In some embodiments, scoring component 170 may collect information regarding a member's participation in one or more internal social networks from social network component 140, e.g., directly and/or via profile manager 160. In some embodiments, the input items of information may be specified to take into account the member's influence on others within the social network, as well as the influence others have on the member within the social network. Thus, actions performed by the member toward other members of the social network may be monitored and/or otherwise measured, as well as actions performed by others toward the member. In some embodiments, informal interactions not managed by a social network component 140 (such as e-mails and real-world meetings) may also be considered. In some possible implementations, an aggregate value for the informal engagement facet for a member A may be computed by assigning points to input items of information including the following:
Other members following and/or followed by member A.
Objects contributed and/or shared by member A.
Other members viewing and/or performing other actions on objects contributed and/or shared by member A.
Commentary and/or suggestions for improvement provided for member A, and/or other actions performed on member A on the social network, by other members of the social network.

In some embodiments, a profile completion facet may represent a measure of whether a member has posted and/or otherwise input information in a number of specified important categories to the member's profile as managed by profile manager 160, and/or to the member's online profile as available to the social network. In some embodiments, profile elements appropriately important to the professional community may be specified, e.g., by an administrator or other personnel, for tracking for this input facet by scoring component 170. In some possible implementations, an aggregate value for the profile completion facet may be computed by assigning points to completed profile elements including the following:
Photograph.
Job/Business card information.
Biography.
Employment history.
Education.
Internet profiles.
Professional interests.
Expertise.
Relocation preferences.

In some embodiments, a skills facet may represent a measure of the level to which a member's skills match the requirements for the member's current job. Any suitable input information may be specified, e.g., by an administrator or other suitable personnel, for collection by scoring component 170 as relevant to the skills measure. In one example, administrator(s), manager(s) and/or other suitable personnel may designate the skills that are required for each job category, and may designate a proficiency level (e.g., on a scale of one to five) required for each skill in a given job category. A member's current proficiency level for a skill may then be determined by a subjective rating on the same scale (e.g., one to five), which may be provided by the member him/herself, a manager, another generic member, and/or any other suitable personnel or any combination of the foregoing. In some embodiments, the combination may be weighted such that ratings provided by, e.g., managers are weighted more heavily than the subjective ratings provided by the members themselves in determining current skill level. In some embodiments, a difference may then be computed between the member's current skill level and the required level for each skill required by the member's job. The differences, representing skill gaps, for all required skills may then be combined (optionally in a weighted fashion) to compute an aggregate value for the skills facet. In addition, in some embodiments, information regarding a member's skills that are not among the set specified (e.g., by an administrator) as required for the member's current job may also be considered as part of the skills facet. In some cases, consideration of these extra skills may aid a professional community in identifying a member as a candidate for another job with a different skill set than the member's current job.

Accordingly, in some possible implementations, an aggregate value for a skills facet may be computed by assigning points to the following items of input information:
Difference between current skill level and required level for each skill (positive or negative points).
Member assigning him/herself a skill (and/or a proficiency level in such skill) not specified (e.g., by an administrator or manager) as required for his/her job, especially if aligned with another job in which the member may be interested.

In some embodiments, an external sources facet may represent a measure of a member's actions performed outside the context of professional networking system 100. As discussed above, one example of an external source from which input information may be collected is an external social network. In some embodiments, an administrator or other suitable personnel may specify a set of external sources to be monitored or analyzed, or from which data is otherwise to be received for computation of an aggregate value for the external sources facet. Such personnel may also specify points to be assigned to specific items of input information. For example, when collecting information regarding a member's participation in one or more external social networks, an administrator may decide how such information should be viewed based on the priorities of the professional community. For a community involved in networking-oriented activities such as sales, information indicating that the member has a high degree of influence in external social networks may be valued positively. However, for a community in an industry such as defense contracting that values secrecy, an administrator may decide to assign negative points to information indicating a high degree of external social networking influence.

As discussed above, it should be appreciated that the foregoing discussion is by way of example only. Any suitable set of one or more input facets may be utilized by a system such as professional networking system 100 with scoring component 170 for evaluating a member of a professional community, as aspects of the invention are not limited in this respect.

In some embodiments, scoring component 170 may be further configured to combine the aggregate values computed for all of the input facets into a single evaluation score indicating the member's value to the professional community. In some embodiments, the combination may make use of a set of weights allowing some of the input facets to contribute more heavily than others to the evaluation score, in accordance with the needs and values of the professional community. Any suitable set of weights may be used (including equal or unequal weights), as aspects of the invention are not limited in this respect. In some embodiments, administrator(s) and/or other suitable personnel may configure scoring component 170 with a specified set of weights, depending on the preferences of the particular professional community. For example, some communities may value informal engagement more highly than other facets, while other communities may value formal learning or effectiveness more highly than other facets. In other embodiments, however, a specified set of weights may simply be a default set that is not configured by any administrator or other personnel. In some embodiments, to provide consistency of evaluation and the opportunity for benchmarking, the same set of weights may be applied across the professional community as a whole. However, this is only an example, and aspects of the invention are not limited in this respect. In some alternative embodiments, weights applied to input facets may not be the same for different members, or may only be the same within subsets of the professional community, such as within job categories, within manager groups, or within any other suitable divisions.

In some embodiments, when a member's evaluation score has been computed, it may be stored by profile manager 160, and/or may be displayed via user interface 180 to user portal 110. In some embodiments, a member may be allowed to view or otherwise be provided an indication of his/her current evaluation score at his/her convenience, at any time throughout the year, outside of the context of a formal performance review process. In some embodiments, the evaluation score may be updated outside of the performance review process, for example at predetermined intervals throughout the year, or in response to any suitable triggering event(s). In some embodiments, the updating of the evaluation score may be significantly more frequent than the traditional performance review, such as updating on a monthly, weekly, daily, or even more frequent than daily basis. In some embodiments, a member's evaluation score may be updated any time an item of input information changes in a way that would change the evaluation score. As discussed above, such real-time dynamic updating and personal access to one's evaluation score may aid a member of a professional community in continuously assessing his/her marketability and maintaining engagement and empowerment in his/her own professional development. In some embodiments, a member may thus be enabled to view his/her evaluation score at some point prior to a formal performance review, to make some positive change to an input facet, and then to have the evaluation score re-computed for the better, before the performance review actually occurs.

In some embodiments, a member may be provided an indication of a normalized version of his/her evaluation score, which may aid the member in benchmarking him/herself against other members of the professional community. For example, in some embodiments, a member's absolute evaluation score may be converted into a percentile with reference to the highest evaluation score currently held by any member of the community, with reference to the highest evaluation score currently held in a subset of the community with which the member is affiliated, with reference to the highest evaluation score ever held in the community, and/or with reference to any other suitable reference value. In other examples, a member's evaluation score may be normalized into a tenth or quartile rather than a percentile, or to any other normalized value that may be useful as a benchmark. Members' absolute evaluation scores and/or normalized evaluation scores, once computed, may be used in any suitable way, as aspects of the invention are not limited in this respect. In the examples described hereafter, references to “evaluation scores” should be understood to refer to absolute scores and/or normalized scores.

In some embodiments, a member's evaluation score may not be viewable or otherwise accessible by other generic members of the professional community. In this respect, a member may view his/her own normalized evaluation score and get a sense of how many other members of the community have higher and/or lower evaluation scores than him/herself, but may not be able to determine the identities of other members with higher and/or lower scores. In other embodiments, however, evaluation scores may be made public, e.g., within an internal social network, or among a subset of generic members of the professional community, or an option may be provided to make a member's evaluation score available to one or more other members.

In some embodiments, for example, options may be available to a member, e.g., through social network component 140, to have his/her evaluation score, and/or information about his/her evaluation score, shared with other members of the professional community in various circumstances. Some or all of such options may be available by default, and/or some or all may be configured for availability by an administrator or other suitable personnel. Any suitable options may be provided, as aspects of the invention are not limited in this respect.

In some embodiments, options for members to share their evaluation scores may be configured to promote recognition and/or competition in a game-like style. In one example, a member may be given the option to have a notification posted to the entire social network, or to a specified subset of members on the social network, whenever his/her evaluation score increases, and/or whenever his/her evaluation score reaches a particular threshold. In another example, a member may be given the option to have a notification posted to the entire social network, or to a specified subset of members on the social network, if his/her evaluation score becomes the best of all members in the professional community, and/or of a specified subset of members in the professional community. In another example, a member may be given the option to have a notification sent to a specified other member of the community when the first member's evaluation score becomes higher than the other member's evaluation score. In yet another example, members may be given the option to be listed on a publicly accessible list if their normalized evaluation scores are above a specified threshold, such as the top 1% or the top 10 scores in the community. It should be appreciated, however, that all of the foregoing are merely examples, and any type of sharing options, or no sharing options at all, may be implemented, as aspects of the invention are not limited in this respect. In addition, in some alternate embodiments, sharing options may be activated and/or deactivated solely by discretion of the professional community, e.g., as represented by one or more administrators, or by discretion of other personnel such as managers, without giving a choice to individual members to control how their evaluation scores are shared.

In some embodiments, a member may be provided, e.g., through member interface 182, not only an indication of the member's own evaluation score, but also an indication of one or more of the input facet values that contributed to that score, and/or an indication of how those input facet values were calculated. In some embodiments, this breakdown of a member's evaluation score may also be accessible by one or more other generic members of the professional community. However, in other embodiments, other generic members may not have access to the breakdown of a particular member's evaluation score, even if those other generic members have access to that member's combined score itself.

In some cases, having access to the breakdown of one's own evaluation score into input facets and/or input information items may provide a member with an in-depth understanding of how he/she is being evaluated, of what facets contribute to the evaluation, and of how he/she can take action to improve his/her evaluation. In addition, when a member accesses his/her evaluation score and/or breakdown on a regular basis outside of the formal performance review context, the member may be enabled to retain focus on his/her performance and to be cognizant of what specific actions and/or events cause particular changes in his/her evaluation score. In some embodiments, alerts and/or other notifications may be provided to a member when his/her evaluation score, and/or one or more input facets contributing to his/her evaluation score, improves or declines. When this occurs, by checking to see what new input information contributed to the change, the member may learn about what strategies are more and less effective in improving the member's value to the professional community.

In some embodiments, a member may be provided the capability, e.g., via member interface 182, to make hypothetical changes to one or more of the input facets, and to view how his/her evaluation score would change based on those hypothetical changes. For example, if a member is considering taking a particular action, such as completing a learning offering, teaching a course, setting a new goal for him/herself, being a mentor for another member, or any other suitable action, the member in some embodiments could input this hypothetical future action to scoring component 170 and have the resulting hypothetical change to his/her evaluation score computed and displayed. In this way, a member may be able to plan an effective strategy for prioritizing actions to most efficiently improve his/her value to the professional community.

In some embodiments, professional networking system 100 may be programmed to provide a member with automatic recommendations for actions that the member could perform to increase his/her evaluation score. Such recommendations may be determined and/or provided in any suitable way, as aspects of the invention are not limited in this respect. For example, professional networking system 100 may be programmed and/or otherwise configured (e.g., with input from an administrator or other suitable personnel) with a set of rules specifying how to create recommendations for improving an evaluation score. In one example, the system may highlight for the member one or more of the member's goals that are incomplete or have been inactive. In another example, the system may notify the member of one or more learning offerings that were recently completed by one or more members with higher evaluation scores. In another example, the system may notify the member of one or more members with higher evaluation scores whom the member does not follow on the internal social network, but whom others do follow on the social network. In another example, the system may notify the member of one or more members with lower evaluation scores who do not follow the member, but who do follow one or more other members. In another example, the system may remind the member of one or more profile elements for which the member has not yet provided complete information. In another example, the system may notify the member of one or more learning offerings that were completed by one or more other members having higher skill level assessments. In some of these examples and in others, the system may determine an action to recommend to the member by identifying an action that was previously performed by one or more other members, which resulted in increased evaluation scores for those other members. It should be appreciated, however, that each of the foregoing is merely an example, and aspects of the invention are not limited to any particular technique(s) for providing recommendations.

In some embodiments, regardless of the access rights of other generic members to a particular member's evaluation score and/or breakdown, the particular member's evaluation score and/or breakdown may still be visible to the member's manager(s), and/or to administrators as deemed appropriate, e.g., by the professional community. In some embodiments, managers may use the knowledge of the evaluation scores and/or breakdowns of the members that they manage to implement effective strategies for the development of those members as valuable resources. For example, in some embodiments a manager may, e.g., via manager interface 184, view the evaluation scores of members in his/her group to determine who is struggling and may need extra attention, and/or who is excelling and may be able to provide assistance to those who are struggling. In some embodiments, a manager may also view the breakdown of input facets for members in his/her group to determine the specific areas in which members excel and/or struggle, and to determine how best to target improvement efforts. In some embodiments, professional networking system 100 may provide a manager the capability to make hypothetical changes to input facets and/or input information items for members in his/her group, and/or may provide automatic recommendations related to members in his/her group, in a similar fashion to that described above for individual members.

In some embodiments, knowledge of the breakdown of input facets for members in a manager's group may aid the manager in identifying members to be assigned to particular tasks. For example, a manager may assign a task requiring a specific skill to a member whose skills facet demonstrates high proficiency in that skill. In another example, a manager may identify a member who is strong in the informal engagement facet as a potential mentor for one or more other members. In some embodiments, evaluation scores and/or breakdowns may provide managers and/or other suitable personnel with useful information for making human resources decisions, such as those related to compensation, hiring and promotion. For example, when a manager must allocate a limited compensation budget among group members who compare relatively equally in some measures such as formal goals and/or skills, the manager may look to other input facets and/or to overall evaluation scores as differentiators to establish differing compensation levels for the group members. In another example, when a job position is open and candidates are being considered for the job, a target evaluation score and/or one or more target values for specific input facets may be set as filters and/or otherwise as relevant criteria to aid in selecting among the available candidates. In some embodiments, target scores may be publicized such that individual members may search for position openings that match their own evaluation scores and/or input facet values, skill sets and/or proficiency levels, and/or any other relevant criteria.

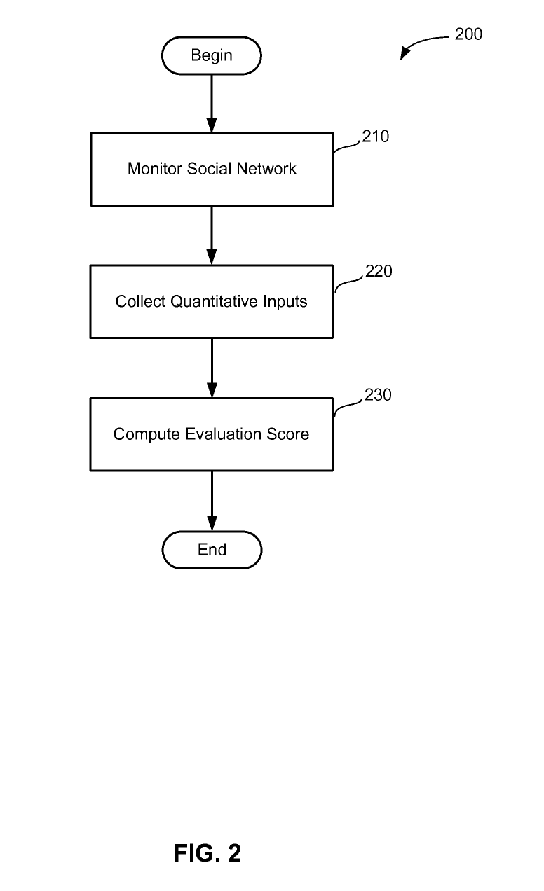

It should be appreciated from the foregoing that one embodiment of the invention is directed to a method 200 for evaluating a member of a professional community, as illustrated in FIG. 2. Method 200 may be performed, for example, by one or more components of a professional networking system 100 such as scoring component 170, although other implementations are possible, as method 200 is not limited in this respect. Method 200 begins at act 210, at which one or more social networks may be monitored by the evaluation system. As discussed above, such social networks may be internal and/or external to the professional community. At act 220, quantitative inputs regarding a member's participation in the one or more social networks may be collected. Examples of suitable quantitative inputs reflecting a member's informal engagement within the professional community and/or external to the professional community are discussed above, although other examples are possible. At act 230, the collected quantitative inputs may be incorporated in computing an evaluation score indicating the member's value to the professional community. Examples of suitable techniques for computing such an evaluation score from input information are discussed above, although other examples are possible. In some embodiments, as discussed above, multiple input facets, including one or more facets corresponding to the quantitative information regarding the member's participation in the one or more social networks, may be integrated or otherwise combined, in a weighted or unweighted fashion, into an evaluation score. However, these are merely some embodiments, and other embodiments may not utilize multiple input facets. For example, in some embodiments, a member may be evaluated solely on measures of informal engagement, or on any other suitable facet that could otherwise serve as one of multiple facets in a combined score.

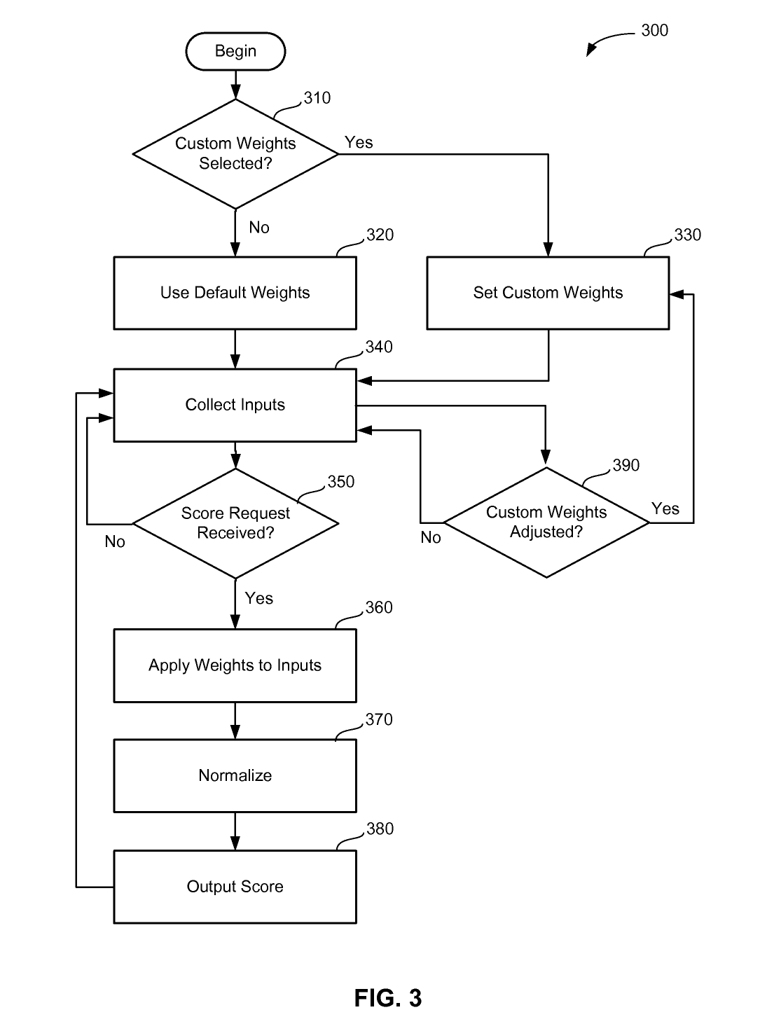

FIG. 3 illustrates an exemplary method 300 for computing an evaluation score from multiple inputs, in accordance with some embodiments of the present invention. Method 300 may be performed, for example, by one or more components of a professional networking system 100 such as scoring component 170, although other implementations are possible, as method 300 is not limited in this respect. Method 300 begins at act 310, at which the system may determine whether a custom set of weights has been selected. As discussed above, in some embodiments, a custom set of weights to be applied to input facets in computing an evaluation score may be configured by appropriate personnel (e.g., one or more administrators) to conform to the needs and/or preferences of the professional community. At act 310, if it is determined that no custom weights have been selected, method 300 may proceed to act 320, at which a set of default weights may be enabled. Any suitable weights may be used as default weights, as aspects of the invention are not limited in this respect. Such default weights may be programmed during development of the evaluation system, and/or may be set and/or updated at any suitable time, e.g., by a system developer. In some embodiments, the default set of weights may be a uniform set that does not weight any input facet more heavily than any other input facet.

If it is determined at act 310 that a set of custom weights has been selected, method 300 may proceed to act 330, at which the custom weights may be set in place of the default weights, for later use in method 300. Once either default weights or custom weights have been enabled, method 300 may then proceed to act 340, at which inputs (e.g., input information corresponding to input facets) may be collected for a particular member of the professional community. While inputs are being collected, the evaluation system may also determine, at act 390, whether any custom weights have been adjusted (e.g., by an administrator). This may also include custom weights being newly selected in place of default weights that were previously enabled. If it is determined that custom weights have been adjusted, method 300 may loop back to act 330, at which the new custom weights may be set in place of the weights that were previously enabled. If it is determined that no custom weights have been adjusted, method 300 may return to act 340 to continue collecting inputs.

At act 350, a determination may be made as to whether a score request has been received. For example, a score request may be received when a user (e.g., an administrator, manager or generic member) logs in to the system (e.g., via a user portal and user interface) and requests to review the evaluation score of the member for whom inputs are being collected. If no score request is currently received, method 300 may return to act 340 to continue collecting inputs. However, once a score request is received, method 300 may proceed to act 360 to compute an evaluation score. It should be appreciated, however, that this is merely one example, and other paths of processing are possible. For instance, in some embodiments, the evaluation system may not always wait to receive a score request before computing an evaluation score, but may compute an evaluation score whenever a new input is collected, and may output an evaluation score (e.g., in the form of an alert or other notification) whenever a new input results in a change to the evaluation score. In yet other embodiments, the evaluation system may compute an updated evaluation score at regular intervals of time. Any suitable such technique for updating evaluation scores may be utilized, as aspects of the invention are not limited in this respect.

At act 360, the set of weights that is currently enabled may be applied to the collected inputs to compute an evaluation score. In one example, input items of information may be aggregated into values for a plurality of input facets, each having a weight in the enabled set of weights. Each input facet value may then be multiplied by its corresponding weight, and the resulting weighted facets may then be summed to compute the combined evaluation score. This is only one example, however, and it should be appreciated that aspects of the invention are not limited to any particular technique for applying weights to inputs. At act 370, the computed evaluation score may be normalized with reference to one or more scores of one or more other members of the professional community, as discussed above. However, in some embodiments, this act may not be required, and the absolute evaluation score may be used without normalization. In still further embodiments, both the absolute and the normalized evaluation score may be retained for further use. Thus, at act 380, the absolute and/or the normalized evaluation score may be output, e.g., to a display via a user interface, or to a further data processing module, or to any other suitable location. Method 300 may then loop back to act 340, at which further inputs may be collected for the next update of the member's evaluation score.

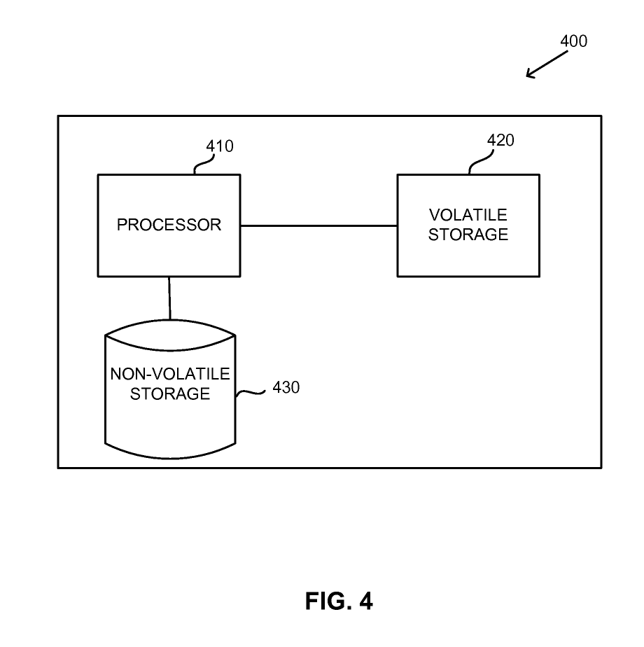

A system for evaluating members of a professional community in accordance with the techniques described herein may take any suitable form, as aspects of the present invention are not limited in this respect. An illustrative implementation of a computer system 400 that may be used in connection with some embodiments of the present invention is shown in FIG. 4. One or more computer systems such as computer system 400 may be used to implement any of the functionality described above. The computer system 400 may include one or more processors 410 and one or more computer-readable storage media (i.e., tangible, non-transitory computer-readable media), e.g., volatile storage 420 and one or more non-volatile storage media 430, which may be formed of any suitable non-volatile data storage media. The processor 410 may control writing data to and reading data from the volatile storage 420 and/or the non-volatile storage device 430 in any suitable manner, as aspects of the present invention are not limited in this respect. To perform any of the functionality described herein, processor 410 may execute one or more instructions stored in one or more computer-readable storage media (e.g., volatile storage 420), which may serve as tangible, non-transitory computer-readable media storing instructions for execution by processor 410.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-discussed functions. The one or more controllers can be implemented in numerous ways, such as with dedicated hardware, or with general purpose hardware (e.g., one or more processors) that is programmed using microcode or software to perform the functions recited above.

In this respect, it should be appreciated that one implementation of embodiments of the present invention comprises at least one computer-readable storage medium (i.e., at least one tangible, non-transitory computer-readable medium, e.g., a computer memory, a floppy disk, a compact disk, a magnetic tape, or other tangible, non-transitory computer-readable medium) encoded with a computer program (i.e., a plurality of instructions), which, when executed on one or more processors, performs above-discussed functions of embodiments of the present invention. The computer-readable storage medium can be transportable such that the program stored thereon can be loaded onto any computer resource to implement aspects of the present invention discussed herein. In addition, it should be appreciated that the reference to a computer program which, when executed, performs above-discussed functions, is not limited to an application program running on a host computer. Rather, the term “computer program” is used herein in a generic sense to reference any type of computer code (e.g., software or microcode) that can be employed to program one or more processors to implement above-discussed aspects of the present invention.

The phraseology and terminology used herein is for the purpose of description and should not be regarded as limiting. The use of “including,” “comprising,” “having,” “containing,” “involving,” and variations thereof, is meant to encompass the items listed thereafter and additional items. Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting. The invention is limited only as defined by the following claims and the equivalents thereto.

What is claimed is:

1. A method for evaluating a person who is a member of a professional community, the method comprising:
collecting informal engagement information comprising quantitative information regarding the person's participation in at least one social network;
collecting formal evaluation information provided by one or more managers of the person; and
combining, using at least one processor, at least the informal engagement information and the faunal evaluation information in computing a score indicating the person's value to the professional community.

2. The method of claim 1, wherein the at least one social network is internal to the professional community.

3. The method of claim 1, wherein the at least one social network is external to the professional community.

4. The method of claim 1, wherein computing the score comprises:
collecting a plurality of inputs relevant to evaluating the person's value to the professional community, the plurality of inputs comprising the informal engagement information and the formal evaluation information;
allowing an administrator to specify a set of weights to control relative contributions of at least the informal engagement information and the formal evaluation information to the score; and
applying the specified set of weights to the plurality of inputs to compute the score indicating the person's value to the professional community.

5. The method of claim 4, wherein collecting the plurality of inputs comprises monitoring the person's compliance with learning requirements.

6. The method of claim 4, wherein collecting the plurality of inputs comprises:
monitoring the person's proficiency in a set of skills specified for the person's job; and
collecting information regarding the person's proficiency in at least one skill not included in the set of skills specified for the person's job.

7. The method of claim 4, further comprising:
providing to the person an indication of the computed score indicating the person's value to the professional community; and
providing to the person an indication of at least some of the plurality of inputs used in computing the score.

8. The method of claim 4, further comprising:
applying the selected set of weights to compute scores evaluating other members of the professional community; and
providing to the person an indication of how the computed score indicating the person's value to the professional community compares to the scores computed for the other members of the professional community.

9. The method of claim 4, further comprising:
providing an interface allowing the person to make hypothetical changes to at least one of the plurality of inputs used in computing the score; and
providing to the person an indication of how the computed score would change based on the hypothetical changes to the at least one of the plurality of inputs.

10. The method of claim 4, further comprising recommending to the person an action that would increase the computed score.

11. The method of claim 10, wherein the recommending comprises identifying an action performed by at least one other member of the professional community, wherein the action resulted in an increased score for the at least one other member of the professional community.

12. The method of claim 1, wherein collecting the quantitative information comprises computing a measure of the person's influence on other people within the at least one social network.

13. The method of claim 12, wherein computing the measure of the person's influence comprises monitoring occurrences of events selected from the group consisting of: other people following the person on the at least one social network; the person contributing and/or sharing objects on the at least one social network; other people viewing objects contributed and/or shared by the person on the at least one social network; other people performing actions on objects contributed and/or shared by the person on the at least one social network; and other people providing impressions on the person on the at least one social network.

14. The method of claim 1, wherein collecting the quantitative information comprises computing a measure of other people's influence on the person within the at least one social network.

15. The method of claim 1, wherein collecting the quantitative information comprises collecting information regarding a level of completion of the person's profile on the at least one social network.

16. The method of claim 1, further comprising:
providing to the person, outside of a formal performance review, an indication of the computed score indicating the person's value to the professional community; and
prior to the person's next formal performance review, re-computing the score based at least in part on at least one action performed by the person after the indication of the computed score.

17. Apparatus comprising:
at least one processor; and
at least one computer-readable medium storing processor-executable instructions that, when executed by the at least one processor, perform a method for evaluating a person who is a member of a professional community, the method comprising:
collecting informal engagement information comprising quantitative information regarding the person's participation in at least one social network;
collecting formal evaluation information provided by one or more managers of the person; and
combining at least the informal engagement information and the formal evaluation information in computing a score indicating the person's value to the professional community.

18. The apparatus of claim 17, wherein the at least one social network is internal to the professional community.

19. The apparatus of claim 17, wherein the at least one social network is external to the professional community.

20. The apparatus of claim 17, wherein computing the score comprises:
collecting a plurality of inputs relevant to evaluating the person's value to the professional community, the plurality of inputs comprising the informal engagement information and the formal evaluation information;
allowing an administrator to specify a set of weights to control relative contributions of at least the informal engagement information and the formal evaluation information to the score; and
applying the specified set of weights to the plurality of inputs to compute the score indicating the person's value to the professional community.

21. The apparatus of claim 20, wherein collecting the plurality of inputs comprises monitoring the person's compliance with learning requirements.

22. The apparatus of claim 20, wherein collecting the plurality of inputs comprises:
monitoring the person's proficiency in a set of skills specified for the person's job; and
collecting information regarding the person's proficiency in at least one skill not included in the set of skills specified for the person's job.

23. The apparatus of claim 20, wherein the method further comprises:
providing to the person an indication of the computed score indicating the person's value to the professional community; and
providing to the person an indication of at least some of the plurality of inputs used in computing the score.

24. The apparatus of claim 20, wherein the method further comprises:
applying the selected set of weights to compute scores evaluating other members of the professional community; and
providing to the person an indication of how the computed score indicating the person's value to the professional community compares to the scores computed for the other members of the professional community.

25. The apparatus of claim 20, wherein the method further comprises:
providing an interface allowing the person to make hypothetical changes to at least one of the plurality of inputs used in computing the score; and
providing to the person an indication of how the computed score would change based on the hypothetical changes to the at least one of the plurality of inputs.

26. The apparatus of claim 20, wherein the method further comprises recommending to the person an action that would increase the computed score.

27. The apparatus of claim 26, wherein the recommending comprises identifying an action performed by at least one other member of the professional community, wherein the action resulted in an increased score for the at least one other member of the professional community.

28. The apparatus of claim 17, wherein collecting the quantitative information comprises computing a measure of the person's influence on other people within the at least one social network.

29. The apparatus of claim 28, wherein computing the measure of the person's influence comprises monitoring occurrences of events selected from the group consisting of: other people following the person on the at least one social network; the person contributing and/or sharing objects on the at least one social network; other people viewing objects contributed and/or shared by the person on the at least one social network; other people performing actions on objects contributed and/or shared by the person on the at least one social network; and other people providing impressions on the person on the at least one social network.

30. The apparatus of claim 17, wherein collecting the quantitative information comprises computing a measure of other people's influence on the person within the at least one social network.

31. The apparatus of claim 17, wherein collecting the quantitative information comprises collecting information regarding a level of completion of the person's profile on the at least one social network.

32. The apparatus of claim 17, wherein the method further comprises:
providing to the person, outside of a formal performance review, an indication of the computed score indicating the person's value to the professional community; and
prior to the person's next formal performance review, re-computing the score based at least in part on at least one action performed by the person after the indication of the computed score.

33. At least one computer-readable storage medium encoded with computer-executable instructions that, when executed, perform a method for evaluating a person who is a member of a professional community, the method comprising:
collecting informal engagement information comprising quantitative information regarding the person's participation in at least one social network;
collecting formal evaluation information provided by one or more managers of the person; and
combining at least the informal engagement information and the formal evaluation information in computing a score indicating the person's value to the professional community.

34. The at least one computer-readable storage medium of claim 33, wherein the at least one social network is internal to the professional community.

35. The at least one computer-readable storage medium of claim 33, wherein the at least one social network is external to the professional community.

36. The at least one computer-readable storage medium of claim 33, wherein computing the score comprises:
collecting a plurality of inputs relevant to evaluating the person's value to the professional community, the plurality of inputs comprising the informal engagement information and the formal evaluation information;
allowing an administrator to specify a set of weights to control relative contributions of at least the informal engagement information and the formal evaluation information to the score; and
applying the specified set of weights to the plurality of inputs to compute the score indicating the person's value to the professional community.

37. The at least one computer-readable storage medium of claim 36, wherein collecting the plurality of inputs comprises monitoring the person's compliance with learning requirements.

38. The at least one computer-readable storage medium of claim 36, wherein collecting the plurality of inputs comprises:
monitoring the person's proficiency in a set of skills specified for the person's job; and
collecting information regarding the person's proficiency in at least one skill not included in the set of skills specified for the person's job.

39. The at least one computer-readable storage medium of claim 36, wherein the method further comprises:
providing to the person an indication of the computed score indicating the person's value to the professional community; and
providing to the person an indication of at least some of the plurality of inputs used in computing the score.

40. The at least one computer-readable storage medium of claim 36, wherein the method further comprises:
applying the selected set of weights to compute scores evaluating other members of the professional community; and
providing to the person an indication of how the computed score indicating the person's value to the professional community compares to the scores computed for the other members of the professional community.

41. The at least one computer-readable storage medium of claim 36, wherein the method further comprises:
providing an interface allowing the person to make hypothetical changes to at least one of the plurality of inputs used in computing the score; and
providing to the person an indication of how the computed score would change based on the hypothetical changes to the at least one of the plurality of inputs.

42. The at least one computer-readable storage medium of claim 36, wherein the method further comprises recommending to the person an action that would increase the computed score.

43. The at least one computer-readable storage medium of claim 42, wherein the recommending comprises identifying an action performed by at least one other member of the professional community, wherein the action resulted in an increased score for the at least one other member of the professional community.

44. The at least one computer-readable storage medium of claim 33, wherein collecting the quantitative information comprises computing a measure of the person's influence on other people within the at least one social network.

45. The at least one computer-readable storage medium of claim 44, wherein computing the measure of the person's influence comprises monitoring occurrences of events selected from the group consisting of: other people following the person on the at least one social network; the person contributing and/or sharing objects on the at least one social network; other people viewing objects contributed and/or shared by the person on the at least one social network; other people performing actions on objects contributed and/or shared by the person on the at least one social network; and other people providing impressions on the person on the at least one social network.

46. The at least one computer-readable storage medium of claim 33, wherein collecting the quantitative information comprises computing a measure of other people's influence on the person within the at least one social network.

47. The at least one computer-readable storage medium of claim 33, wherein collecting the quantitative information comprises collecting information regarding a level of completion of the person's profile on the at least one social network.

48. The at least one computer-readable storage medium of claim 33, wherein the method further comprises:
providing to the person, outside of a formal performance review, an indication of the computed score indicating the person's value to the professional community; and
prior to the person's next formal performance review, re-computing the score based at least in part on at least one action performed by the person after the indication of the computed score.
